(19) United States
(12) Patent Application Publication
(10) Pub. No.: US 2026/0246001 A1
(43) Pub. Date: Aug. 20, 2026

(54) BATTERY MODULE WITH CONTROLLED INSULATING FLUID CIRCULATION

(71) Applicant: Industry-University Cooperation Foundation Sunmoon University, Asan-si (KR)

(72) Inventors: Minsoo KANG, Asan-si (KR); Jonghwan YUN, Pyeongtaek-si (KR); Jonghwan KIM, Asan-si (KR)

(73) Assignee: Industry-University Cooperation Foundation Sunmoon University, Asan-si (KR)

(21) Appl. No.: 19/057,246

(22) Filed: Feb. 19, 2025

(30) Foreign Application Priority Data
Feb. 17, 2025 (KR) 10-2025-0020289

(51) Int. Cl. H01M 10/613; H01M 10/625; H01M 10/6567; H01M 50/204

(52) U.S. Cl. CPC H01M 10/613; H01M 10/6567; H01M 50/204; H01M 10/625

(57) ABSTRACT

A battery module with controlled insulating fluid circulation according to various embodiments of the present invention is disclosed to achieve the above-described objectives. The battery module includes a housing forming an exterior, a plurality of battery cells disposed at regular intervals in an internal space of the housing, an insulating fluid provided in the internal space of the housing and having thermal conductivity and insulating properties for distributing heat of the battery cells, and a fluid circulation unit provided inside the housing to circulate the insulating fluid.

### CROSS-REFERENCE TO RELATED APPLICATION

This application claims priority to and the benefit of Korean Patent Application No. 10-2025-0020289,filed on Feb. 17, 2025, the disclosure of which is incorporated herein by reference in its entirety.

### BACKGROUND

### 1. Field of the Invention

The present invention relates to a thermal management and cooling system for a battery module, and more particularly, to a battery module capable of effectively controlling the heat of a battery cell using an insulating fluid, preventing thermal runaway through uniform fluid circulation, and maximizing cooling efficiency, and a battery pack structure including the same.

### 2. Discussion of Related Art

As application fields using large lithium-ion batteries, such as electric vehicles, energy storage systems (ESSs), hybrid electric vehicles (HEVs), and the like, rapidly expand, thermal management technology of a battery module is becoming an important factor in determining the safety and performance of the system. Although lithium-ion batteries provide high energy density and a long lifetime, failure to effectively control the heat generated during use can lead to serious problems such as thermal runaway. Thermal runaway is a phenomenon in which heat spreads to nearby cells as a specific battery cell overheats, which may lead to fatal accidents such as fire or explosion. Therefore, the importance of thermal management technology is increasingly emphasized.

Currently, thermal management methods mainly used in battery modules include air cooling and liquid cooling. Air cooling has the advantage of a simple design and low cost, but it is not suitable for large battery modules that use high density energy due to its low cooling efficiency. In addition, since the heat dispersion between battery cells is not uniform, a problem in which heat is concentrated in a specific area is likely to occur. On the other hand, liquid cooling provides high cooling efficiency, but the structure is complicated and there is a possibility that electrical components inside the battery module may come into contact with water, and thus there is a risk of corrosion or short circuits. In particular, liquid cooling has a disadvantage of significantly increasing design and maintenance costs for large systems.

Recently, in order to overcome the limitations of air cooling and liquid cooling, oil cooling technology using an insulating fluid is attracting attention. The insulating fluid simultaneously provides high thermal conductivity and electrical insulation and may efficiently remove heat by being in direct contact with the surface of the battery cell. However, the existing oil cooling technology has a problem in that the fluid flow becomes unstable due to concentration of the fluid in a specific area or turbulence, and the entire battery cell may not be uniformly cooled. In addition, while a vehicle is driving, the flow of cooling fluid is distorted by acceleration and an inertial force, which frequently reduces the efficiency of thermal management. These problems are particularly noticeable in large battery modules and complex thermal management systems and act as major factors that hinder practical use.

To solve the above problems, the present invention proposes a new structure and method which enables uniform thermal dispersion between battery cells by introducing a cooling technology based on an insulating fluid, prevents thermal runaway by stably maintaining fluid circulation, and simultaneously maximizes the stability and performance of the battery.

### SUMMARY OF THE INVENTION

The present invention is for effectively preventing thermal runaway occurring in a battery module, while enabling uniform heat dispersion between battery cells and stable circulation of the cooling fluid to address the above-mentioned issues.

The problems to be solved by the present invention are not limited to the problems mentioned above, and other problems that are not mentioned will be clearly understood by those skilled in the art from the following description.

A battery module with controlled insulating fluid circulation according to various embodiments of the present invention is disclosed to address the above-mentioned issues. The battery module includes a housing forming an exterior, a plurality of battery cells disposed at regular intervals in an internal space of the housing, an insulating fluid provided in the internal space of the housing and having thermal conductivity and insulating properties for distributing the heat of the battery cells, and a fluid circulation unit provided inside the housing to circulate the insulating fluid.

In an alternative embodiment, the insulating fluid of the present invention may include silicone oil, carbon nanoparticles, and a hydrophobic surfactant.

In an alternative embodiment, the fluid circulation unit may include a motor that generates a driving force for driving the fluid circulation unit, a plurality of shafts connected to the motor and disposed one-to-one in spaces between the plurality of battery cells, a shaft connection gear that is provided on each of the plurality of shafts, transmits power between the shafts, and synchronizes and rotates the shafts, and a plurality of impellers that are each provided on one of the plurality of shafts, operate according to the rotation of the shaft, and generate a flow of the insulating fluid.

In an alternative embodiment, the housing may include a motor installation space in which the motor is installed, wherein the motor installation space is formed as a separate individual space so that the insulating fluid does not reach the motor installation space, and the shaft connection gear is located in the motor installation space.

In an alternative embodiment, the plurality of impellers may include a first impeller including a central hub and a plurality of blades, wherein the blades are formed in a circular structure having a curvature that gradually increases from a center to an edge, and a second impeller formed in a structure in which a spiral blade is wound around a central shaft, wherein the spiral blade is disposed in an inclined shape toward the central shaft.

In an alternative embodiment, when the plurality of battery cells are arranged in two rows, a space formed outside a first row of the battery cells may be defined as a first space, a space formed between the first row and a second row may be defined as a second space, and a space formed outside the second row may be defined as a third space, the plurality of shafts may be disposed between the rows of the battery cell, the first impeller may be disposed in each of the first space and the third space, and the second impeller may be disposed in the second space.

In an alternative embodiment, the second impeller may be provided on each of the plurality of shafts, and second impellers provided on adjacent shafts may be disposed to rotate in opposite directions.

In an alternative embodiment, a plurality of protruding members may be formed on an inner wall of the housing to protrude inward to prevent eddying of the insulating fluid and form turbulence.

In an alternative embodiment, the plurality of shafts may be provided to be slidable in a height direction of the housing.

Other specific details of the present invention are included in the detailed description and drawings.

### BRIEF DESCRIPTION OF THE DRAWINGS

Various aspects are now described as reference to drawings, where similar reference numbers are generally used to refer to similar components. In the following embodiments, for purposes of explanation, a number of specific details are presented to provide a comprehensive understanding of one or more aspects. However, it will be apparent that such aspect(s) may be implemented without these specific details. The drawings including:

FIG. 1 is an exemplary view illustrating a cross-sectional view of a battery module with controlled insulating fluid circulation according to an embodiment of the present invention;

FIG. 2 is an exemplary view illustrating a perspective view of the battery module according to an embodiment of the present invention;

FIG. 3 is an exemplary view for describing a fluid circulation unit according to an embodiment of the present invention; and

FIGS. 4A and 4B are exemplary views illustrating a configuration of a battery pack including a plurality of battery modules according to an embodiment of the present invention.

### DETAILED DESCRIPTION OF EXEMPLARY EMBODIMENTS

Various embodiments and/or aspects are now disclosed with reference to the drawings. In the following description, for the purpose of explanation, a number of specific details are disclosed to help the overall understanding of one or more aspects. However, it may be apparent to those of ordinary skill in the technical field of the present invention that such aspect(s) may be implemented without these specific details. The following description and accompanying drawings describe specific exemplary aspects of one or more aspects in detail. However, these aspects are exemplary and some of the various methods in the principles of various aspects may be used, and the descriptions herein are intended to include all such aspects and their equivalents. Specifically, “embodiments,” “examples,” “aspects,” and the like used herein may not be interpreted as indicating any aspect or design is better than or as has advantages over other aspects or designs.

Hereinafter, the same or similar components are given the same reference numbers regardless of the drawing numbers, and redundant descriptions thereof will be omitted. In addition, in describing the embodiments disclosed in the present specification, when it is determined that a detailed description of related known technologies may obscure the gist of the embodiments disclosed in the present specification, the detailed description thereof will be omitted. In addition, the accompanying drawings are only for facilitating easy understanding of the embodiments disclosed in the present specification, and the technical ideas disclosed in the present specification are not limited by the accompanying drawings.

Although “first,” “second,” and the like are used to describe various elements or various components, these elements or components are, of course, not limited by these terms. These terms are merely used to distinguish one element or component from another element or component. Therefore, it is evident that a first element or component mentioned below may also be a second element or component within the technical spirit of the present invention.

Unless otherwise defined, all terms (including technical and scientific terms) used in the present specification may be used with meanings commonly understood by those skilled in the art to which the present invention pertains. In addition, terms defined in commonly used dictionaries are not to be ideally or excessively interpreted unless explicitly defined.

In addition, the term “or” is intended to refer to an inclusive “or” rather than an exclusive “or.” That is, unless otherwise specified or not clear from the context, “X uses A or B” is intended to refer to one of the natural inclusive substitutions. That is, when X uses A; X uses B; or X uses both A and B, “X uses A or B” may be applied in either of these cases. In addition, the term “and/or” used herein should be understood to refer to and include all possible combinations of one or more of the related items listed.

In addition, the terms “include” and/or “comprise” refer to the presence of corresponding features and/or components but are not intended to exclude the presence or addition of one or more other features, components and/or groups thereof. In addition, unless otherwise specified or not clear from the context as far as indicating a singular form, the singular should be generally interpreted as meaning “one or more” in the present specification and the claims.

When it is mentioned that a component is “coupled” or “connected” to another component, it should be understood that the component may be directly connected or connected to the other component, but still another component may present therebetween. On the other hand, when it is mentioned that a component is “directly coupled” or “directly connected” to another component, it should be understood that there are no other components therebetween.

The suffixes “module” and “unit” used in the following description for components are given or used interchangeably in consideration of only the ease of writing the specification, and do not have a distinct meaning or role in themselves.

When an element or layer is referred to as “above” or “on” another element or layer, it includes not only cases in which the element or layer is directly on the other element or layer, but also cases in which there is another layer or element interposed therebetween. On the other hand, when a component is referred to as being “directly on” or “right above,” it indicates that there are no other components or layers therebetween.

The spatially relative terms “below,” “beneath,” “lower,” “above,” “upper,” and the like may be used to easily describe the relationship between one component and other components as shown in the drawings. Spatially relative terms should be understood as terms that include different orientations of the device in use or operation in addition to the orientation shown in the drawings.

For example, when a component shown in the drawings is turned over, a component described as “below” or “beneath” another component may be placed “above” the other component. Accordingly, the exemplary term “below” may include both below and above directions. The component may be oriented in different directions, and thus spatially relative terms may be interpreted according to orientation.

The purpose and effects of the present invention and technical configurations for achieving them will become apparent with reference to embodiments described in detail below together with the accompanying drawings. In describing the present invention, when it is determined that a detailed description of a known function or configuration may unnecessarily obscure the gist of the present invention, the detailed description will be omitted. Further, the terms to be described below are defined in consideration of functions in the present disclosure and may vary depending on the intention or practice of a user or an operator.

However, the present invention is not limited to the embodiments disclosed below and may be implemented in various different forms. These embodiments are provided to make the present invention complete and to fully inform those skilled in the art to which the present invention pertains of the scope of the disclosure, and the present invention is only defined by the scope of the claims. Therefore, the definition should be made based on the contents throughout this specification.

A battery cell is the most basic electrochemical device that stores electrical energy and releases it as needed, and a high energy density cell such as a lithium-ion battery may be mainly used in various applications such as an electric vehicle, an energy storage system (ESS), a hybrid electric vehicle (HEV), and the like.

A battery module refers to a unit structure designed to facilitate electrical connection and thermal management between cells by assembling a plurality of battery cells into a certain structure, and the battery pack is composed of a unit that may be applied to a large energy system by collectively connecting a plurality of battery modules. These battery systems may be mainly used for various purposes, such as driving systems for transportation means such as electric vehicles, an ESS for large-scale energy storage, or a power supply of portable electronic devices.

According to an embodiment, several common problems may occur during utilization of the battery system. In particular, when the heat generated by the electrochemical reaction is not properly controlled, overheating in a specific cell may lead to thermal runaway and may compromise the safety of the module and the pack unit. In high power systems such as electric vehicles, this thermal management issue is more pronounced, and inefficient heat dispersion may lead to shorter battery life, energy loss, or serious fire risks. In addition, since the battery pack should pursue miniaturization and weight reduction while maintaining high energy density, harmony between the structural design and thermal management system is required. Existing air cooling or liquid cooling technologies often have complex designs or insufficient cooling efficiency, so the limitations of thermal management technologies are clearly revealed in large battery systems. These problems reduce the reliability of the battery system and act as factors leading to increased costs and maintenance complexity.

The present invention is a new approach to solving the above problems and is designed to improve thermal management efficiency in battery cell, module, and pack units through a cooling system using an insulating fluid, prevent thermal runaway, and simultaneously secure the safety and reliability of the system.

A battery module 1000 with controlled insulating fluid circulation (“hereinafter, referred to as a battery module 1000”) according to an embodiment of the present invention may be a new type of battery module designed to satisfy both the efficiency of thermal management and structural stability. The battery module 1000 is designed such that the insulating fluid circulates between and around battery cells 120 to effectively remove heat from the surface of the battery cells, thereby preventing overheating and maintaining uniform heat dispersion. The circulation of the insulating fluid is implemented through a fluid circulation unit 130, and a plurality of shafts 131 and impellers 133 and 134 may cooperate with each other to stabilize the fluid flow and efficiently disperse heat throughout the battery cell.

In an embodiment, the internal structure of the battery module 1000 is partitioned by a housing 100 to ensure smooth fluid circulation, and the inside of the housing 100 is divided into a battery cell installation space 100a and a motor installation space 110. This division prevents the insulating fluid from affecting the motor or electrical components, thereby ensuring both thermal management performance and electrical stability. In an embodiment, in the process of fluid circulation, the impellers on adjacent shafts may rotate in opposite directions and may uniformly maintain the flow of fluid so that heat between the battery cells is not concentrated in a specific area.

In addition, in an embodiment, the battery module 1000 may operate not only as a single configuration, but also a plurality of modules 1000-1, 1000-2, and 1000-3 may be combined to form a battery pack 1000a. Such a combination may be effectively utilized in high power applications such as large-scale energy storage systems or electric vehicles, and each module is designed to enable independent thermal management to maintain the stability and performance of the entire pack. This greatly improves the scalability and applicability of the battery pack and provides design flexibility.

Such a configuration is a cooling technology using an insulating fluid, which overcomes the limitations of existing air and liquid cooling methods and ensures uniform heat dispersion and a stable operating environment throughout the battery module and pack. In addition, by optimizing the flow of fluid, it is possible to extend the lifetime of the battery system and improve reliability, and it is possible to satisfy the cooling performance and stability required in various application environments.

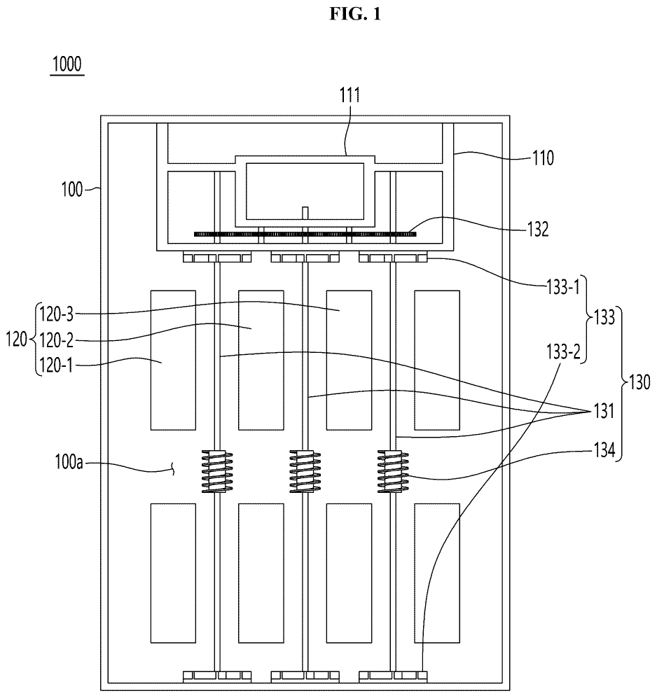

Hereinafter, a detailed configuration and operation principle of the battery module 1000 with controlled insulating fluid circulation according to an embodiment of the present invention will be described in detail with reference to FIGS. 1 to 4. The arrangement and interaction of each component of the present invention will be clarified through the drawings, and the thermal management and stabilization functions provided by the battery module 1000 will be described in detail.

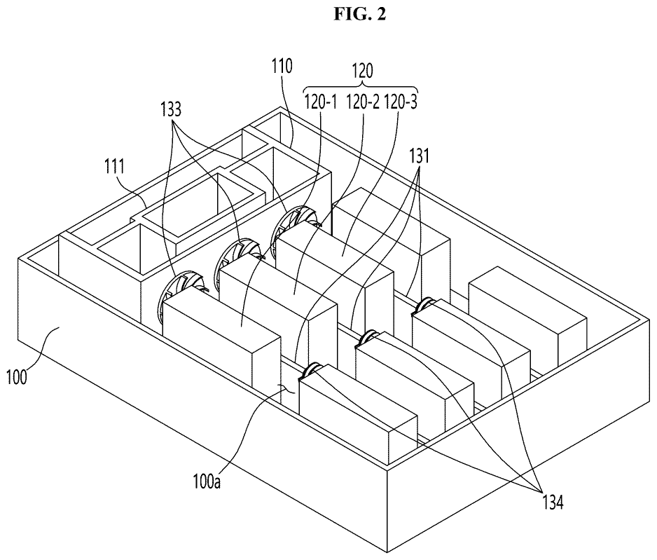

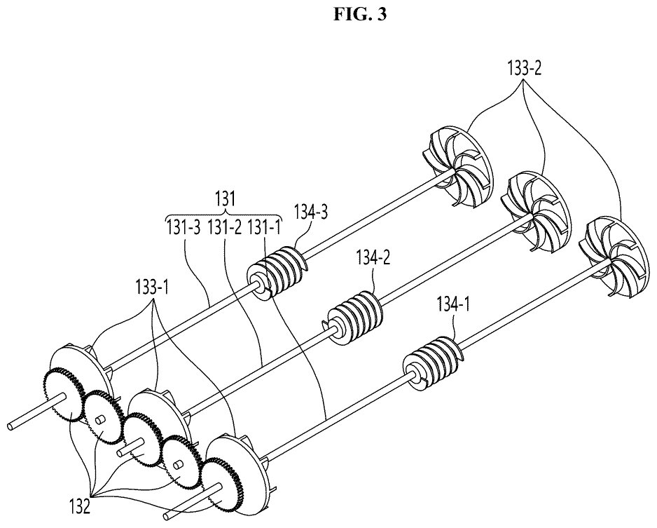

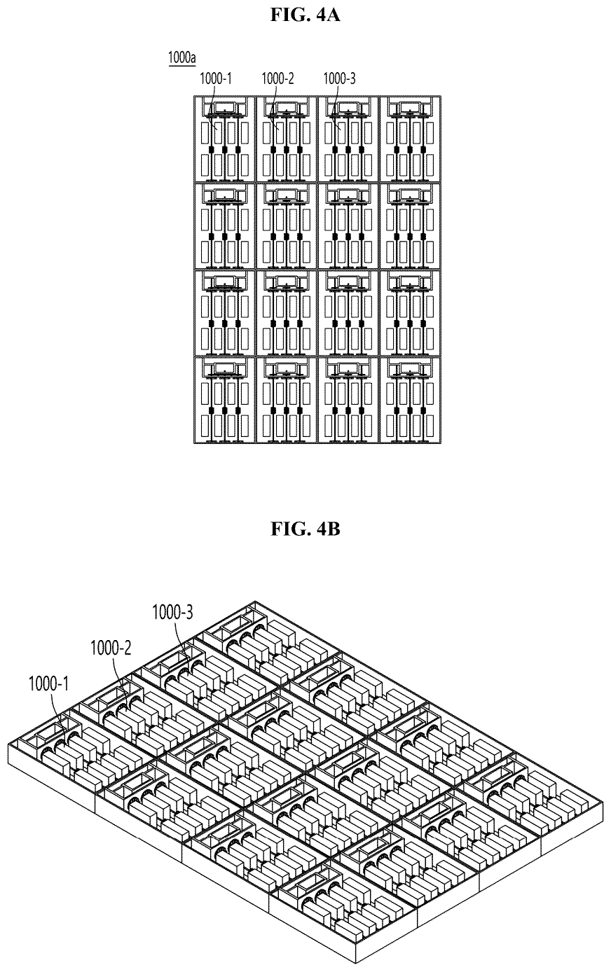

FIG. 1 is an exemplary view illustrating a cross-sectional view of a battery module with controlled insulating fluid circulation according to an embodiment of the present invention. FIG. 2 is an exemplary view illustrating a perspective view of the battery module according to an embodiment of the present invention. FIG. 3 is an exemplary view for describing a fluid circulation unit according to an embodiment of the present invention. FIGS. 4A and 4B are exemplary views illustrating a configuration of a battery pack including a plurality of battery modules according to an embodiment of the present invention.

Referring to FIG. 1, the battery module 1000 of the present disclosure may include a housing 100, a plurality of battery cells 120, an insulating fluid, and a fluid circulation unit 130. The components included in the battery module are exemplary and may be variously changed according to the technical idea of the present invention, but are not limited thereto.

According to an embodiment, the battery module 1000 may include the housing 100 forming an exterior. The housing 100 forms an exterior of the battery module 1000, provides an internal space, and serves to protect the battery cells 120. A battery cell installation space 100a may be formed so that the plurality of battery cells 120 may be fixedly disposed therein. The arrangement of battery cells in the battery cell installation space 100a may be set to maintain an appropriate interval between cells so that the insulating fluid may efficiently flow.

For example, the battery cells 120 may be arranged in series or in parallel inside the housing 100, and the interval between cells may be optimized to maximize cooling efficiency and heat dispersion. Such an arrangement may contribute to removing heat by the insulating fluid coming into even contact with the surface of each battery cell 120 and controlling the flow of fluid so that an overheating zone does not occur.

This arrangement enables efficient thermal management between the battery cells 120 through cooperation with the insulating fluid and the fluid circulation unit 130, and the arrangement of the plurality of cells may ensure the expandability of the battery pack 1000a unit while maintaining the overall thermal stability of the battery module 1000.

According to an embodiment, a plurality of protruding members protruding inward may be formed on the inner wall of the housing 100 to prevent eddying of the insulating fluid and to form turbulence.

More specifically, the protruding member is disposed between the battery cells 120 and along the fluid circulation path around the battery cells and serves to increase heat transfer efficiency by adjusting the flow direction and speed of the fluid. The protruding member may be integrally formed on the inner wall of the housing or may be manufactured as a separate component and assembled. The shape of the protruding member may have any of various cross-sections such as a rectangle, a triangle, and a spiral, and is designed according to the battery cell arrangement and the characteristics of the fluid flow. For example, a rectangular protrusion may guide the flow of fluid in a predetermined direction, and a triangular protrusion may adjust the flow speed of the fluid or concentrate the fluid in a specific direction. A spiral protrusion provides a rotational force to the fluid to enable more uniform heat dispersion.

The position of the protruding member may be selectively disposed on an inner wall of the housing 100, such as an upper portion, a lower portion, or a side surface of the battery cell 120, and is designed to optimize the fluid circulation path while minimizing interference between the battery cells. For example, the protruding member disposed in the space between the upper end and the lower end of the battery cell guides the insulating fluid to flow evenly in the up and down directions, and the protruding member disposed on the side surface enhances the lateral circulation of the fluid to provide uniformity in thermal management. Such a configuration prevents overheating in a specific area inside the battery module 1000 and enables uniform heat dispersion as a whole, thereby improving the performance and lifetime of the battery cell.

In various embodiments, the protruding member may be disposed in an area adjacent to the fluid circulation path formed in the space between the battery cells 120 among the inner walls of the housing 100. Specifically, the protruding member may be limitedly provided in a first space located at an upper end of the battery cell 120, a second space that is an intermediate section between the battery cells, and a third space located at a lower end of the battery cell in order to efficiently control the flow of fluid generated in the fluid circulation unit 130. This positioning contributes to optimizing the flow path of the fluid to effectively prevent overheating problems in specific areas and maximize fluid circulation efficiency.

The protruding member may be designed in harmony with the impellers 133 and 134 of the fluid circulation unit 130. For example, the protruding member located in the first space guides the fluid discharged from a first impeller 133-1 (or centrifugal impeller) to be uniformly dispersed, and the protruding member in the second space assists the flow control of the second impeller 134 (spiral impeller) so that the fluid smoothly passes between the battery cells 120. The protruding member of the third space stabilizes the downward flow of the fluid so that heat dispersion at the lower end is smoothly performed.

In addition, the protruding member may be disposed in a specific pattern according to the flow speed and direction formed in the fluid circulation unit 130. For example, the protruding member of the second space is designed to have a spiral or triangular structure to rotate or accelerate the flow of fluid so that it is uniformly distributed around the battery cell 120. The protruding members of the first space and the third space are designed to have a rectangular shape to linearly guide the flow of fluid and to come into contact with the surface of the battery cell as widely as possible.

Such a position of the protruding member may operate together with the impeller of the fluid circulation unit 130 to stabilize the fluid flow throughout the battery cell, and minimize the heat concentration in a specific area, thereby maximizing the thermal management efficiency of the battery module 1000. This is designed such that the protruding member is optimized according to the battery cell arrangement and the fluid path and plays a key role in controlling the flow of the insulating fluid within the housing 100.

According to an embodiment, referring to FIGS. 1 and 2, the housing 100 includes a motor installation space 110, and the motor installation space 110 accommodates a motor installed therein to generate a driving force for the fluid circulation unit 130. The motor installation space 110 is partitioned from other areas inside the housing 100 so that the insulating fluid does not directly penetrate and is designed so that parts related to the motor may be protected from the insulating fluid.

A motor connection portion 111 is provided in the motor installation space 110, and the motor connection portion 111 may be formed as a structural element that supports the motor so that the motor is stably seated. The motor connection portion 111 serves as a platform designed to allow the motor to be accurately disposed and fixed, thereby maintaining the alignment between the motor and a shaft connection gear 132 to enable efficient power transmission. Referring to FIG. 2, the motor connection portion 111 serves to designate a position for smoothly maintaining the connection between the motor and the shaft 131, and the motor may be provided to transmit rotational power to the fluid circulation unit 130 through the shaft connection gear 132. This structure supports the motor to be stably maintained even under vibrations or external impacts and enables efficient power transmission even when the motor installation space 110 is isolated from the insulating fluid.

According to an embodiment, the battery module 1000 may include the plurality of battery cells 120 disposed in the internal space of the housing 100 at predetermined intervals.

The plurality of battery cells 120 are disposed so that the cells do not interfere with each other, and through this, the insulating fluid smoothly circulates between the cells. The arrangement of respective cells minimizes heat transfer between the cells and enables uniform heat dispersion.

Referring to FIGS. 1 and 2, the battery cells 120 are arranged in series or in parallel inside the housing 100 and are fixedly disposed in the battery cell installation space 100a. The plurality of battery cells 120 may include a first battery cell 120-1, a second battery cell 120-2, a third battery cell 120-3, and the like, and the battery cells have the same size and shape and are arranged at regular intervals. The interval ensures a flow path of the insulating fluid, allowing uniform heat removal across the entire surface of the battery cell.

In addition, the battery cells 120 are disposed in harmony with the plurality of shafts 131 and the fluid circulation unit 130 in the housing 100. The interval between the battery cells is designed to optimize heat transfer efficiency and fluid flow through interaction with the impellers 133 and 134 of the fluid circulation unit 130. As shown in FIG. 1, the battery cell 120 is stably fixed in the housing 100, and referring to FIG. 2, the insulating fluid discharged from the fluid circulation unit 130 may be configured to prevent overheating and achieve uniform heat dispersion while circulating between the battery cells.

In addition, in an embodiment, the battery module 1000 may include an insulating fluid provided in the internal space of the housing 100 and having thermal conductivity and insulation for dispersing the heat of the battery cell.

The insulating fluid circulates between the battery cells 120 and in the surrounding space and provides a stable operating environment for the battery cells by maintaining electrical insulation while maximizing heat transfer efficiency.

The insulating fluid of the present invention may include silicone oil, carbon nanoparticles, and a hydrophobic surfactant.

In particular, when composed of a composition including silicone oil, carbon nanoparticles, and a hydrophobic surfactant, the insulating fluid of the present invention optimizes the balance between thermal conductivity and insulation, thereby providing superior thermal management performance compared to existing technologies.

Specifically, the silicone oil forms the main matrix of the insulating fluid and provides high thermal stability and excellent fluidity. The carbon nanoparticles form fine heat conduction channels in the insulating fluid to expand the heat transfer path and may quickly resolve heat concentration in a specific area. The hydrophobic surfactant maintains the physical stability of the fluid by helping the components in the insulating fluid to be uniformly dispersed. The combination of the above-described three components may be a key factor in maximizing the thermal management performance of the battery cell.

According to an embodiment, the insulating fluid includes silicone oil, carbon nanoparticles, and a hydrophobic surfactant, and each component may be provided through the following configuration ratio. The silicone oil may be included in an amount of 80 to 90 parts by weight, the carbon nanoparticles may be included in an amount of 5 to 15 parts by weight, and the hydrophobic surfactant may be included in an amount of 1 to 5 parts by weight based on 100 parts by weight of the total fluid. This configuration ratio is essential for maintaining a balance between the thermal conductivity and insulation of the insulating fluid and maximizing the long-term stability of the fluid and the performance of the battery module 1000.

In particular, when the amount of silicone oil is less than 80 wt %, the basic matrix of the insulating fluid is not sufficiently formed, and thus the viscosity of the fluid may be lowered. This may cause a problem in that the insulating fluid is not effectively circulated by the impellers 133 and 134 of the fluid circulation unit 130 and heat transfer efficiency between the battery cells 120 is lowered. On the other hand, when the amount of silicone oil exceeds 90 wt %, the concentration of carbon nanoparticles is lowered and the heat conduction path is reduced, which may increase the possibility that heat is concentrated in a specific area, resulting in overheating of the battery cell.

When the carbon nanoparticles are included in an amount of less than 5 wt %, a thermal conduction network is not sufficiently formed in the fluid, which may significantly reduce heat transfer efficiency. This may cause heat to be concentrated in a specific cell of the battery module 1000, and there is a risk of causing thermal runaway. Conversely, when the amount of carbon nanoparticles exceeds 15 wt %, the viscosity of the fluid is excessively increased, which may reduce the operating efficiency of the fluid circulation unit 130 and place an excessive load on the operation of the impellers 133 and 134. This may lead to overheating of the motor or an increase in energy consumption.

When the hydrophobic surfactant is included in an amount of less than 1 wt % by weight, the dispersion of the components in the fluid is not uniform, so there is a high possibility that the carbon nanoparticles settle or the fluid becomes unstable when used for a long time. On the other hand, when the amount of hydrophobic surfactant is greater than 5 wt %, the viscosity of the fluid may be excessively lowered or bubbles may be generated in the fluid, which may cause irregularities in flow in the fluid circulation path.

Therefore, the heat conductivity and insulation of the battery module 1000 may be optimized by providing the insulating fluid through the above composition ratio. In particular, when 87 wt % silicone oil, 8 wt % carbon nanoparticles, and 5 wt % hydrophobic surfactant are included, an optimal balance between heat transfer efficiency and fluid stability may be provided, thereby ensuring uniform heat dispersion of the battery cell and a stable operating environment. This configuration plays a key role in maximizing thermal management performance inside the battery module and improving the reliability of the system.

According to an embodiment of the present invention, the battery module 1000 may include the fluid circulation unit 130 provided inside the housing 100 to circulate an insulating fluid. The fluid circulation unit 130 guides the insulating fluid to smoothly circulate between and around the battery cells 120, thereby contributing to maximizing thermal management efficiency.

In an embodiment, the fluid circulation unit 130 may include a motor that generates a driving force for driving the fluid circulation unit 130. The motor is provided in the motor installation space 110 to control the operation of the fluid circulation unit 130 and transmits a rotational force through the shaft 131 and the shaft connection gear 132. The motor has an optimized rotational speed and output characteristics to generate the flow rate and pressure required for the fluid circulation path and serves to maintain a uniform fluid flow inside the battery module 1000.

In an embodiment, the motor supports forward and reverse rotation so that the fluid circulation unit 130 may adjust the flow direction of the fluid according to the heat dispersion demand inside the battery module. Accordingly, heat concentration occurring in a specific area may be effectively eliminated, and uniform heat management throughout the battery cell is possible.

In addition, the motor is designed in consideration of energy efficiency and may include a protection device to stably operate even in an overheating and overload state. For example, a heat blocking device or an insulating structure is additionally provided in the motor installation space 110 to allow the motor to operate in a state completely isolated from the insulating fluid. This configuration extends the lifetime of the motor and contributes to improving the reliability of the entire battery module 1000.

In addition, the fluid circulation unit 130 may include a plurality of shafts 131 connected to the motor and disposed in spaces between the plurality of battery cells 120.

The plurality of shafts 131 are important components of the fluid circulation unit 130 and serve to circulate and uniformly flow the insulating fluid around the battery cell 120 through the impellers 133 and 134.

For example, referring to FIGS. 1 to 3, the plurality of shafts 131 may be disposed to correspond to an interval between the battery cells 120, and may include a first shaft 131-1, a second shaft 131-2, and a third shaft 131-3. Each shaft 131 is connected to the motor through a shaft connection gear 132, and drives the impellers 133 and 134 by receiving the rotational force transmitted from the motor. This arrangement of the shafts 131 optimizes the flow of fluid between the battery cells 120 and allows uniform heat dispersion within the battery module 1000.

In an embodiment, the plurality of shafts 131 may be located on the upper, lower, and side surfaces of the battery cells 120, and the shafts may be disposed in parallel or in series according to the arrangement of the battery cells 120. For example, referring to FIG. 2, the shafts 131 are disposed parallel to the vertical direction of the battery cells 120 so that the insulating fluid may efficiently circulate in the space between the cells.

In various embodiments, the plurality of shafts 131 may also be provided in a sliding structure to facilitate a change in the arrangement of the battery cells 120. This configuration increases design flexibility of the battery module 1000 and allows adaptation to various configurations of the battery pack 1000a. The position and arrangement of the shafts 131 may maximize the performance of the fluid circulation unit 130 and contribute to improving the thermal management efficiency of the battery cell 120.

In addition, the fluid circulation unit 130 may include a shaft connection gear 132 that is provided on each of the plurality of shafts 131, transmits power between the shafts, and synchronizes and rotates the shafts. The shaft connection gear 132 transmits the rotational force transmitted from the motor to the plurality of shafts 131 so that the shafts rotate in a synchronized manner and effectively form the flow of fluid.

Specifically, referring to FIGS. 2 and 3, the second shaft 131-2 of the fluid circulation unit 130 is rotated by being directly connected to the motor, and power is transmitted to the first shaft 131-1 and the third shaft 131-3 through the shaft connection gear 132. This structure allows the rotational force generated from the motor to spread to adjacent shafts around the second shaft 131-2 and allows all shafts to rotate at a synchronized speed.

For example, when the motor rotates the second shaft 131-2 clockwise, the shaft connection gears 132 engaged with the second shaft 131-2 rotate the first shaft 131-1 counterclockwise and the third shaft 131-3 clockwise. The operation is performed through precise engagement between the shaft and the gear tooth structure of the shaft connection gear 132. Accordingly, the impellers 133 and 134 mounted on the plurality of shafts 131 circulate the fluid in complementary rotational directions and maintain the uniformity and stability of the fluid flow.

In the operation process, a centrifugal impeller 133-2 connected to the second shaft 131-2 discharges the fluid to the outside to form an initial flow, and the spiral impellers 134-1 and 134-3 mounted on the first shaft 131-1 and the third shaft 131-3 control the flow of fluid and guide the fluid in a specific direction. Accordingly, the fluid circulates along the space between the battery cells 120 and enables uniform thermal management of the battery cells.

In addition, the shaft connection gear 132 may be designed to stably operate even in an overload state. For example, the shaft connection gear 132 may include a safety device by which an excessive rotational force of the motor is not transmitted to an adjacent shaft, thereby increasing the durability of the fluid circulation unit 130 and the stability of the battery module 1000. This structure maximizes the circulation efficiency of the fluid and effectively prevents heat concentration that may occur in a specific area.

According to the embodiment, the motor installation space 110 may be formed as a separate space so that the insulating fluid does not reach the motor, and in this case, the shaft connection gear 132 may be located in the motor installation space 110.

The shaft connection gear 132 located in the motor installation space 110 is directly engaged with an output shaft of the motor and transmits a rotational force to the second shaft 131-2 through the gear tooth structure. Subsequently, the gear engaged with the second shaft 131-2 sequentially transmits the rotational force to the first shaft 131-1 and the third shaft 131-3 so that the shafts rotate in a synchronized manner. In this structure, since the shaft connection gear 132 is disposed in a protected state inside the motor installation space 110, the shaft connection gear 132 does not come into direct contact with the external insulating fluid and may be protected from wear and corrosion.

A closed structure is provided between the motor installation space 110 and the internal space of the housing 100 to completely block the penetration of the insulating fluid. For example, a sealing structure or bearing housing is provided at a portion where the motor installation space 110 and the shaft 131 are connected, and thus the shaft 131 may be smoothly rotated and the penetration of the insulating fluid may be prevented.

This configuration allows the motor and the shaft connection gear 132 to operate stably for a long period of time and maximizes the efficiency of the fluid circulation unit 130. In addition, by placing the shaft connection gear 132 in the motor installation space 110, the utilization of the internal space of the battery module 1000 may be increased, and the fluid circulation path may be designed more simply. These structural features contribute to further improving the stability and reliability of the present invention.

In addition, the fluid circulation unit 130 may include a plurality of impellers, which are each provided on one of the plurality of shafts 131, operate according to the rotation of the shafts, and generate the flow of the insulating fluid.

In an embodiment, the plurality of impellers may include a first impeller 133 (or a centrifugal impeller) formed in a circular structure including a central hub and a plurality of blades, wherein the blades have a curvature that gradually increases from the center to an edge, and a second impeller 134 (or a spiral impeller) formed in a structure in which the spiral blades are wound around the central shaft, and the spiral blades are disposed in an inclined shape in the central shaft direction.

Specifically, referring to FIG. 3, the first impeller 133 has a centrifugal structure, and the plurality of blades are radially disposed around a central hub. The blade has a curvature that increases from the center to an edge and serves to discharge the fluid from the axial direction to the outside. This structure strongly generates an initial flow of fluid, allowing the fluid to be effectively dispersed into the space outside the battery cell. The first impeller 133 is particularly advantageous for activating the circulation of the fluid and for rapidly moving the fluid to prevent heat accumulation.

The second impeller 134 has a spiral blade, and the blade is wound around the central shaft and disposed in an inclined shape. This spiral structure imparts a rotational force to the fluid, thereby stably guiding a fluid flow in a specific direction. The second impeller 134 stabilizes the fluid flow in the space between the battery cells 120 and minimizes turbulence, thereby providing uniformity in thermal management. In particular, the second impeller 134 may contribute to reducing the temperature difference between the battery cells by precisely controlling the flow of fluid.

The combination of the first impeller 133 and the second impeller 134 simultaneously implements the initial flow generation and stabilization of the fluid and improves the overall thermal management performance of the battery module 1000. Each impeller is operated by the rotational force of the shaft 131 and maintains a constant fluid flow to enable efficient thermal management throughout the battery cell. These structural features maximize the performance and lifetime of the battery cell while enhancing the safety and reliability of the system.

According to an embodiment of the present invention, when a plurality of battery cells are arranged in two rows, a space formed outside the first row of the battery cells may be defined as a first space, a space formed between the first row and the second row may be defined as a second space, and a space formed outside the second row may be defined as a third space. These spaces are used as paths through which the insulating fluid circulates, and the plurality of shafts 131 are disposed between the rows of the battery cells, and the first impeller 133 and second impeller 134 are provided.

In this case, the plurality of shafts may be disposed between the rows of battery cells, the first impeller 133 may be disposed in each of the first space and the third space, and the second impeller 134 may be disposed in the second space.

In detail with reference to FIGS. 1 to 3, the plurality of shafts 131 may be disposed between the rows of battery cells, and the first impeller 133 and the second impeller 134 may be provided on each of the shafts. Referring to FIG. 1, the first impellers 133 (133-1 and 133-2) may be disposed in the first space and the third space, respectively, to form a flow of fluid in an upper region (an upper portion of the battery cell in a first row based on FIG. 1) and a lower region (a lower portion of the battery cell in a second row based on FIG. 1). The first impeller 133 disposed at the upper side moves the fluid in the downward direction in the first space, and the first impeller 133 disposed at the lower side moves the fluid in the upward direction in the third space. This vertical fluid flow ensures uniform heat dispersion throughout the upper portion and the lower portion of the battery cell and effectively prevents overheating in a specific area.

The second impeller 134 may be disposed in the second space located between the first and second rows of battery cells to form a lateral flow of the fluid. The second impeller 134 may be designed with a spiral blade structure to apply a rotational force to the fluid and form a stable and uniform flow along the second space. As a result, heat transfer between the two rows is smoothly performed, and a balanced heat dispersion is maintained between battery cells.

Through the above-described arrangement and configuration, the first impeller 133 guides the circulation of the fluid in a direction from the outside to inside of the battery cells, and the second impeller 134 forms a flow of fluid in the horizontal direction between the battery cells so that multidimensional fluid circulation may be achieved inside the battery module 1000. This structure optimizes heat dispersion in all areas of the battery cell, prevents thermal overload in a specific area, and maximizes the thermal management performance of the module.

According to an embodiment, the second impeller 134 may be provided on each of the plurality of shafts, and second impellers provided on adjacent shafts may be disposed to rotate in opposite directions. This arrangement is designed to maximize the uniformity and stability of fluid flow and may effectively suppress turbulence or inefficient turbulence of the fluid that may occur in a particular area.

Specifically, the adjacent second impellers 134 rotate in opposite directions, thereby preventing the fluid flow from being excessively concentrated at a specific point or causing an imbalance in the flow, and more uniformly distributing the fluid flow. This arrangement efficiently disperses the flow of fluid and helps to uniformly disperse the heat in the battery module. Referring to FIG. 3, it can be seen that the second impeller 134-2 provided on the second shaft 131-2 is disposed in a different rotational direction from the first impeller 134-1 and the third impeller 134-3 provided on the first and third shafts 131-1 and 131-3, respectively.

The configuration allows the insulating fluid to evenly come into contact with all surfaces of the battery cell and prevents a phenomenon in which the fluid is excessively concentrated or insufficient in a specific area. In particular, the second impeller 134 rotates in a direction opposite to the impeller installed on the adjacent shaft so that the flow paths of the fluid are efficiently readjusted while intersecting each other. This quickly removes thermal energy from the surface of the battery cell and maximizes thermal management performance through optimization of the fluid circulation path.

In addition, this opposite rotational arrangement increases the circulation speed of the fluid by maintaining the directionality of the flow while minimizing the turbulence of the fluid. As a result, the opposite rotational arrangement contributes to uniformly maintaining the temperature around the battery cell, preventing performance degradation due to heat overload, and improving the stability and reliability of the entire battery module.

Accordingly, the speed of the fluid is smoothly changed, and the fluid pressure around the battery cell 120 is uniformly distributed. In particular, by minimizing the irregularity of the flow formed as the fluid passes between the battery cells, it is possible to prevent local heat accumulation or excessive heat concentration in a specific area.

In addition, the arrangement of second impellers rotating in opposite directions enables multidimensional circulation of the fluid, thereby overcoming the limitations of the fluid flow in a single direction. This allows heat dispersion to be more uniform throughout the battery module 1000 and contributes to maximizing cooling efficiency by expanding the circulation path of the fluid. For example, the second impeller rotating in one direction pushes the fluid to the upper portion of the battery cell, and the second impeller rotating in opposite direction pushes the fluid to the lower portion so that the fluid flows in the up and down directions simultaneously. Through this, thermal management inside the battery module achieves a multidimensional balance of up and down and left and right.

This arrangement also enhances the operational stability of the entire system while improving fluid circulation efficiency inside the module. For example, uniform circulation of the fluid provides the same heat transfer conditions at all surfaces of the battery cell, which contributes to extending the lifetime of the battery cell and maintaining its performance. Further, the impeller structure rotating in opposite direction is advantageous in reducing noise that may occur in the fluid circulation process and optimizing energy consumption.

That is, the rotation of the adjacent second impeller in opposite direction may increase the balance and efficiency of the fluid circulation, maximize the thermal management performance inside the battery module, and improve the reliability of the battery system.

According to an embodiment of the present invention, the plurality of shafts 131 may be provided to be slidable in the height direction (or thickness direction) of the housing 100. Here, a height direction of the housing 100 refers to a z-axis direction perpendicular to an x-axis/y-axis plane on which the battery cells 120 are disposed. That is, it corresponds to a vertical axis extending from the upper portion to the lower portion of the battery module 1000, which is defined in the vertical direction of the arrangement of the battery cells 120. The movement in the height direction (z-axis) plays an important role in dynamically adjusting the fluid flow between battery cells and maximizing cooling efficiency.

The shaft 131 designed to be slidable in the height direction may provide various effects. Specifically, when excessive heat is generated in a specific battery cell column or row, the shaft 131 may be moved in the z-axis direction to place the fluid circulation path closer to the corresponding region. Accordingly, the first impeller 133 and the second impeller 134 may concentrate the flow of the insulating fluid to the heat generation area, thereby rapidly alleviating the overheating problem.

In addition, the movement in the z-axis direction has an advantage of providing flexibility to reconstruct the overall fluid flow path in three dimensions. Since the heat generation pattern of the battery cell 120 may change over time or depending on an operating environment, the heat dispersion efficiency may be continuously optimized by adjusting the flow of fluid in real time through the movement of the shaft 131 in the height direction. For example, when the heat is concentrated at the upper portion of the battery cell, the shaft 131 may be moved upward to activate an upper impeller, and when the heat at the lower portion increases, the shaft may be moved downward to enhance circulation through a lower impeller.

That is, the shaft 131 designed to be slidable in the height direction (z-axis) of the housing 100 provides flexibility to three-dimensionally adjust the interaction between the battery cell 120 and the fluid circulation unit 130. Accordingly, it is possible to maximize heat dispersion efficiency, secure adaptability according to the operating environment, and improve maintenance convenience and manufacturing process efficiency. This configuration may be an important design feature that may simultaneously enhance the thermal management performance and reliability of the battery module 1000.

In an embodiment, the plurality of shafts 131 may be designed to be slidable along the height direction (z-axis) of the housing 100. To this end, a sliding guide structure capable of guiding and stably supporting the sliding movement of the shaft 131 may be included in the housing 100.

Specifically, a linear guide rail or a track may be formed on an inner wall of the housing 100 or a path on which the shaft 131 is disposed, and the shaft 131 is movable through a sliding block designed to engage with the guide rail. The sliding block is coupled to the lower end or the middle portion of the shaft 131 so that the shaft may smoothly move in the height direction along the rail.

The rail and the block may be implemented with a design that maintains the degree of fixing so that the shaft is not shaken or misaligned even while the shaft is moving. For example, grooves are formed on both sides of the rail so as to guide the shaft to not be separated from the rail, and a low friction material (e.g., polytetrafluoroethylene, PTFE) or roller is attached to the sliding block to minimize the movement resistance of the shaft. Accordingly, the shaft 131 may move in the height direction accurately and smoothly.

In addition, a lead screw or rack-and-pinion mechanism may be applied to fix or control the position of the shaft 131. In the lead screw method, a nut coupled to the shaft moves along the lead screw to adjust the position of the shaft, and in the rack and pinion method, a rack coupled to the shaft engages with a pinion gear to convert rotational motion into linear motion. This mechanism is controlled by a motor or a manual handle, and thus the position of the shaft may be precisely adjusted.

The shaft connection gear 132 is implemented with a design that may operate according to a variable position so that the shaft 131 may stably transmit power and perform a fluid circulation function while moving. For example, by adopting a slidable meshing structure between gears, even when the shaft moves in the height direction, power may be transmitted without interruption. This structure allows the fluid circulation unit 130 to flexibly adapt according to the thermal management requirements of the battery cell 120.

That is, the structure in which the plurality of shafts 131 are designed to be slidable in the height direction of the housing 100 may be implemented by utilizing a mechanism such as a linear guide rail, a sliding block, a lead screw, or a rack-and-pinion. This structure stably and precisely supports the movement of the shaft and may greatly improve thermal management performance and flexibility inside the battery module 1000.

In various embodiments, the battery module of the present invention may include a sensor unit, and whether the motor is operating and the operating speed may be precisely controlled through the sensor unit. The sensor unit interworks with the fluid circulation unit to monitor the flow state of the insulating fluid in real time, thereby optimizing the operating conditions of the motor. The sensor unit is located inside or outside the housing and may include various types of sensors such as a flow sensor, a temperature sensor, a pressure sensor, and a speed sensor. The flow sensor detects the flow speed of the insulating fluid and may transmit a control signal to increase the speed of the motor when the fluid flows below a certain speed or the flow is stagnant. Conversely, when an excessive fluid flow occurs, the flow sensor reduces the speed of the motor to prevent energy waste. The temperature sensor detects the temperature at a specific location in the battery cell or housing, and when an overheated area is found, the motor's operating speed is accelerated to supply more fluid to that area. For example, when the temperature of the central portion of the battery module rises, the motor is accelerated to enhance the circulation of the insulating fluid, thereby rapidly dispersing the heat. The pressure sensor measures the pressure of the fluid in the fluid circulation unit, and when an abnormal pressure increase or decrease is detected in a specific section, the pressure sensor may execute a command to adjust the operating speed of the motor or change the flow path of the fluid. In addition, the speed sensor directly measures the rotational speed of the motor to check whether the actual fluid flow in the fluid circulation unit matches the intended speed. The sensor unit is connected to a central battery cell of the battery module to collect and analyze data on the fluid circulation state to dynamically adjust the operating conditions of the motor. Accordingly, the present invention dynamically controls whether the motor is operating and the speed thereof according to the fluid circulation state, thereby maximizing the thermal management performance of the battery module and simultaneously securing energy efficiency and system stability. For example, the heat generated during a rapid acceleration or charging process in an electric vehicle may be efficiently dispersed, and energy consumption may be minimized, thereby contributing to extending the operating time of the battery pack.

In addition, in an embodiment, the battery module 1000 may include a structure capable of independently blocking each specific battery cell when an emergency situation occurs. This configuration may operate to minimize the impact on the operation of the remaining cells and modules by performing a blocking action limited to the corresponding cell when an abnormal situation such as overheating, overvoltage, overcurrent, fluid leakage, or the like is detected in the battery cell 120.

Specifically, each battery cell 120 may include an individual circuit breaker or switch for controlling power supply. For example, when a current sensor and a temperature sensor connected to each battery cell are installed and a current or temperature exceeding a set safety threshold is detected, the battery module operates an interrupter switch connected to the corresponding cell to stop the power supply. This method isolates a specific cell in which an abnormality has occurred, and thus the remaining cells and the entire module may operate normally.

In addition, a fluid blocking function as well as an electrical blocking function may be additionally included in the connection between the battery cells. For example, a small fluid valve is installed in a fluid circulation path between battery cells to block the path when overheating or leakage occurs in a specific cell. This prevents the insulating fluid from being intensively introduced or lost to the cell where the abnormality has occurred and guides the fluid to be smoothly supplied to other cells. For example, the fluid circulation unit 130 including the first impeller 133 and the second impeller 134 may efficiently manage an abnormal situation by strengthening or stopping the fluid circulation around a specific cell.

Further, the battery module may include an independent sensor module for each battery cell to monitor the real-time state of the corresponding cell. The sensor module measures current, voltage, temperature, fluid flow rate, etc. in real time, and communicates with the battery module to take immediate action when an abnormal situation is detected. For example, when the temperature of a specific cell rapidly rises, the battery module operates the interrupter switch of the corresponding cell and simultaneously redistributes the fluid flow to the adjacent cells to effectively disperse the heat.

In addition, even after a specific battery cell is blocked due to an emergency situation, an independent power path and a fluid circulation path may be designed to ensure stable operation of the remaining cells and the module. For example, even when the interrupter switch of each cell is operated, the fluid circulation unit 130 continues to operate around the adjacent cells to maintain the thermal management function of the entire module.

This configuration enables a rapid response to a specific cell in which an emergency situation has occurred and contributes to increasing the overall safety and reliability of the battery module. In particular, in a high-performance battery application field such as an electric vehicle or an energy storage system (ESS), secondary accidents such as a fire or explosion may be prevented by blocking a specific cell, thereby ensuring user safety and minimizing system damage. As a result, the structure of the present invention enables efficient and independent management in emergency situations and may contribute to greatly improving the life and stability of the battery system.

According to an embodiment of the present invention, the battery pack 1000a may include a plurality of interconnected battery modules 1000. The battery pack 1000a provides a structure in which each battery module 1000 is formed independently, while operating as a single system as a whole.

Specifically, referring to FIGS. 4A and 4B, in the battery pack 1000a, a plurality of battery modules 1000-1, 1000-2, 1000-3, and the like are arranged in a grid shape, and each battery module includes the independent housing 100, the plurality of battery cells 120, and the fluid circulation unit 130. This arrangement ensures uniform heat dispersion and stable operation within the entire pack, while allowing each module to perform heat management independently.

The battery pack 1000a includes a bus bar or a connection terminal for electrical connection between the battery modules 1000, and through this connection, the power of individual modules may be integrated for the entire pack. In addition, since each battery module 1000 in the battery pack includes an independent fluid circulation unit 130, the heat management of a specific module may be selectively controlled when necessary. This maximizes the heat management efficiency of the pack and effectively prevents heat overload that may occur in a specific module.

In the example of FIGS. 4A and 4B, the battery pack 1000a may be implemented with an expandable modular design. This allows the number of battery modules 1000 to be adjusted according to the required capacity and provides the advantage of being able to flexibly respond to various application environments. For example, in a large application environment such as an electric vehicle or an energy storage system, the capacity may be expanded by increasing the number of battery modules, and a pack including a small number of battery modules may be used for home or small electronic devices.

This configuration performs thermal management and power control in an individual module unit and provides integrated operation and expandability as a battery pack as a whole, thereby improving the stability and reliability of the system.

According to various embodiments of the present invention, a battery cooling system utilizing an insulating fluid can overcome the limitations of conventional air-cooling and liquid-cooling methods. The fluid circulation unit, designed to maintain uniform fluid flow between multiple battery cells, employs a combination of centrifugal and helical impellers to enable efficient heat dissipation.

Additionally, the battery module of the present invention is designed to allow multiple modules to be combined to form a battery pack, thereby providing scalability and ease of maintenance. Furthermore, by incorporating sensors, the battery module can detect the temperature of individual battery cells. If overheating is detected in a specific battery cell, the cooling fluid flow can be adjusted, or the affected cell can be isolated to enhance safety.

Through this configuration, the battery module of the present invention provides an efficient cooling system for maintaining the long-term performance and safety of the battery. In particular, it maximizes reliability and efficiency in large-scale battery systems.

The effects of the present disclosure are not limited to the effects mentioned above, and other effects that are not mentioned may be clearly understood by those skilled in the art from the following description.

Although embodiments of the present invention have been described above with reference to the accompanying drawings, those skilled in the art to which the present invention pertains will understand that the present invention may be implemented in other specific forms without changing the technical idea or essential features thereof. Therefore, it should be understood that the embodiments described above are exemplary in all respects and are not restrictive.

The specific implementations described in the present invention are exemplary embodiments, and the scope of the present invention is not limited in any way. For the sake of brevity of the specification, descriptions of conventional electronic configurations, control systems, software, and other functional aspects of the systems may be omitted. In addition, the line connections or connection members between the components illustrated in the drawings represent exemplary functional connections and/or physical or circuit connections and may be replaced or represented as various functional connections, physical connections, or circuit connections in an actual device. In addition, when there is no specific mention such as “essential,” “important,” or the like, it may not be a component that is absolutely necessary for the application of the present invention.

It should be understood that the specific order or hierarchy of steps in the presented processes is an example of exemplary approaches. Based on design priorities, it is to be understood that a specific order or hierarchy of steps in processes may be rearranged within the scope of the present invention. The appended method claims provide elements of various steps in a sample order but are not meant to be limited to the particular order or hierarchy presented.

The description of the presented embodiments is provided so that anyone of ordinary skill in the art may use or implement the present invention. Various modifications to these embodiments will be apparent to those skilled in the art, and the general principles defined herein may be applied to other embodiments without departing from the scope of the present invention. Thus, the present invention should not be limited to the embodiments presented herein but should be interpreted within the broadest range consistent with the principles and novel features presented herein.

What is claimed is:

1. A battery module with controlled insulating fluid circulation, comprising:
a housing forming an exterior;
a plurality of battery cells disposed at regular intervals in an internal space of the housing;
an insulating fluid provided in the internal space of the housing and having thermal conductivity and insulating properties for distributing heat of the battery cells; and
a fluid circulation unit provided inside the housing to circulate the insulating fluid.

2. The battery module of claim 1, wherein the insulating fluid includes silicone oil, carbon nanoparticles, and a hydrophobic surfactant.

3. The battery module of claim 1, wherein the fluid circulation unit includes:
a motor that generates a driving force for driving the fluid circulation unit;
a plurality of shafts connected to the motor and disposed one-to-one in spaces between the plurality of battery cells;
a shaft connection gear that is provided on each of the plurality of shafts, transmits power between the shafts, and synchronizes and rotates the shafts; and
a plurality of impellers that are each provided on one of the plurality of shafts, operate according to the rotation of the shaft, and generate a flow of the insulating fluid.

4. The battery module of claim 3, wherein the housing includes a motor installation space in which the motor is installed,
wherein the motor installation space is formed as a separate individual space so that the insulating fluid does not reach the motor installation space, and
the shaft connection gear is located in the motor installation space.

5. The battery module of claim 3, wherein the plurality of impellers include:
a first impeller including a central hub and a plurality of blades, wherein the blades are formed in a circular structure having a curvature that gradually increases from a center to an edge; and
a second impeller formed in a structure in which a spiral blade is wound around a central shaft, wherein the spiral blade is disposed in an inclined shape toward the central shaft.

6. The battery module of claim 5, wherein, when the plurality of battery cells are arranged in two rows, a space formed outside a first row of the battery cells is defined as a first space, a space formed between the first row and a second row is defined as a second space, and a space formed outside the second row is defined as a third space,
the plurality of shafts are disposed between rows of the battery cells,
the first impeller is disposed in each of the first space and the third space, and
the second impeller is disposed in the second space.

7. The battery module of claim 5, wherein the second impeller is provided on each of the plurality of shafts, and second impellers provided on adjacent shafts are disposed to rotate in opposite directions.

8. The battery module of claim 1, wherein, a plurality of protruding members are formed on an inner wall of the housing to protrude inward to prevent eddying of the insulating fluid and form turbulence.

9. The battery module of claim 3, wherein the plurality of shafts are provided to be slidable in a height direction of the housing.

10. A battery pack comprising a plurality of battery modules with controlled insulating fluid circulation of claim 1, which are interconnected.
